(19) United States
(12) Patent Application Publication
(10) Pub. No.: US 2011/0029885 A1
(43) Pub. Date: Feb. 3, 2011

(54) Confidential Presentations in Virtual Worlds

(75) Inventors: Jan Leonhard Camenisch, Thalwil (CH); Dirk Husemann, Einsiedeln (CH); Dieter Sommer, Zurich (CH)

Correspondence Address: RYAN, MASON & LEWIS, LLP, 90 FOREST AVENUE, LOCUST VALLEY, NY, 11560, US

(73) Assignee: International Business Machines Corporation, Armonk, NY (US)

(21) Appl. No.: 12/512,456

(22) Filed: Jul. 30, 2009

(51) Int. Cl. G06F 3/00; G06F 3/048

(52) U.S. Cl. 715/741; 715/744; 715/757; 715/771; 715/716

(57) ABSTRACT

Methods and apparatus for presenting confidential presentations are presented. For example, a method for providing a confidential presentation includes providing a data stream by a stream server of a provider of the confidential presentation to a participant client, providing virtual world elements from a virtual world provider to the participant client, and forming, by the participant client, virtual world display data comprising the data stream and the virtual world elements. The virtual world provider is distinct from the provider of the confidential presentation.

### FIELD OF THE INVENTION

The present invention relates generally to confidential presentations, and more particularly the invention relates to protecting confidential information within a virtual world presentation.

### BACKGROUND OF THE INVENTION

A virtual world is a computer-based simulation environment where virtual world users are intended to inhabit and interact via avatars. A virtual world user accesses a computer-simulated world which presents perceptual stimuli to the virtual world user, who in turn can manipulate elements of the modeled world and thus experiences telepresence to a certain degree. Such modeled worlds may appear similar to the real world or instead may depict fantasy worlds. Virtual worlds are not limited to games but can encompass computer conferencing, text based chat rooms and collaborative business applications.

By way of example, virtual worlds offer avatars public places in which to meet and hold meetings. However, within a company environment, not all meetings are open to the public. Confidential meetings are often necessary. The community aspects of virtual worlds directly conflict with the need for confidential meetings. In virtual worlds, the servers, and therefore the operators of the virtual world, usually learn the content and metadata of all objects because they need to distribute these pieces of data to the community as part of the virtual world environment.

### SUMMARY OF THE INVENTION

Principles of the invention provide, for example, methods and apparatus for presenting confidential presentations.

For example, in accordance with one aspect of the invention, a method for presenting a confidential presentation is provided. The method includes providing a data stream by a stream server of a provider of the confidential presentation to a participant client, providing virtual world elements from a virtual world provider to the participant client, and forming, by the participant client, virtual world display data comprising the data stream and the virtual world elements. The virtual world provider is distinct from the provider of the confidential presentation.

In accordance another embodiment of the invention, apparatus for providing a confidential presentation is provided. The apparatus includes a stream server of a provider of the confidential presentation and a device for forming a data stream. The apparatus is operative or configured to perform the above method for providing a confidential presentation.

In accordance with yet another embodiment of the invention, other apparatus for providing a confidential presentation is provided. The other apparatus includes a memory and a processor coupled to the memory. The apparatus is operative or configured to perform the above method for providing a confidential presentation.

In accordance with another embodiment of the invention, a system for providing a confidential presentation is provided. The system comprises modules for implementing the above method for providing a confidential presentation.

In accordance with one more embodiment of the invention, a computer program product for providing a confidential presentation is provided. The computer program product comprises a computer readable storage medium having computer readable program code embodied therewith. The computer readable program code comprises computer readable program code configured to perform the above method for providing a confidential presentation.

Aspects of the invention include, for example: providing secure confidential presentations within a virtual world (e.g., a computing environment associated with a virtual application), where access to presentation material is allowed only to invited or authorized participants possessing appropriate credentials (e.g., security credentials); providing a streaming data format for confidential presentations within a virtual world; and providing confidential meetings and presentations within a virtual world, where confidential material exists only on access controlled or secure resources.

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a first system for providing a confidential presentation according to an exemplary embodiment of the invention.

FIG. 2 illustrates a second system for providing a confidential presentation according to an exemplary embodiment of the invention.

FIG. 3 illustrates a first method of providing a confidential presentation according to an exemplary embodiment of the invention.

FIG. 4 illustrates a second method of providing a confidential presentation according to an exemplary embodiment of the invention.

FIG. 5 depicts a computer system that may be useful in implementing one or more aspects and/or elements of the invention.

### DETAILED DESCRIPTION OF THE INVENTION

An avatar is a representation inside of the virtual world of a virtual world user. The avatar can be in the form of a three-dimensional model, a two-dimensional icon or picture, or a text construct. As used herein, an avatar is an object representing, within a virtual world, the embodiment of the virtual world user.

A head-up display is a display, for example, a transparent display, that presents an image without requiring the user to look away from his or her usual viewpoint. The origin of the name stems from the user being able to view information with their head “up” and looking forward, instead of angled down.

A host is the person or user controlling, originating, hosting, or providing content for a secure meeting or confidential presentation. The host, for example, may provide the confidential presentation or presentation material for the confidential presentation.

The term nonparticipant, as used herein, specifies a person or entity not authorized to attend a secure meeting or confidential presentation. Secure access is withheld from nonparticipants

The term authorized participant, as used herein, specifies a user authorized to attend a secure meeting or confidential presentation. For example, authorized participant may be the host, a presenter, or other authorized attendant.

The term presenter, as used herein, specifies an authorized participant that controls a presentation of presentation material during a confidential presentation or confidential meeting. The presenter may be, for example, the host or other authorized participant.

The term real world, as used herein, comprises the environment or world outside of the virtual world. The real world is exclusive of the virtual world.

Streaming media is media that is constantly received by, and normally presented to, an end-user while it is being delivered by a streaming provider using a streaming format. Streaming media is, for example, streaming video, audio, text or multimedia. The name, streaming media, generally refers to the delivery method of the medium rather than to the medium itself. The verb ‘to stream’ is associated from this term streaming media, and means to deliver media in streaming media manner. The noun “data stream” or “stream” is data or media delivered by streaming media, by streaming or by a streaming format.

The term user, as used herein, comprises a confidential presentation or confidential meeting authorized participant, for example a host, a presenter or an authorized participant of the confidential presentation.

A virtual private network (VPN) is a computer network in which at least some of the links between nodes are carried by open connections or virtual circuits in some larger network (e.g., the Internet). One common application is secure communications through the public Internet. A VPN need not have explicit security features, such as authentication or content encryption. VPNs, for example, can be used to separate the traffic of different user communities over an underlying network with strong security features.

A virtual world is a computing environment associated with a virtual application, that is, a computer-based simulation environment where virtual world users are intended to inhabit and interact via avatars. A uses accesses, through a computer, a computer-simulated world which presents perceptual stimuli to the virtual world user, who in turn can manipulate elements of the modeled world and thus experiences telepresence to a certain degree. Such modeled worlds may appear similar to the real world or instead may depict fantasy worlds. The model world may simulate rules based on the real world, rules of the fantasy world, or hybrid rules of real and fantasy worlds. Communication between virtual world users may include, but is not limited to, text, graphical icons, visual, video, sound, and forms using touch and balance senses. Communication with real-time voice communication using voice-over-Internet-protocol (VOIP) is also possible. Virtual worlds are not limited to games but can encompass computer conferencing and text based chat rooms.

Virtual Network Computing (VNC or VNC2) is a graphical desktop sharing system capable of remotely control another computer. Virtual network computing is a screen capture technology that relays a graphical screen and/or updates of the graphical screen from one computer to one or more other computers over a network. Virtual network computing is capable of transmitting the keyboard and mouse events from one computer to another. Virtual network computing uses, for example, the remote frame-buffer (RFB) protocol.

There is a need to enable confidential and secure meetings in virtual worlds such that the audio and video channels can be secure, having content available to only authorized people, i.e., the people invited to the meeting.

An aspect of the invention provides a data stream, comprising confidential presentation material, to a virtual world. The data stream comprises streaming media or streaming data provided in streaming format. Access to the data stream within the virtual world is prevented without authorization, that is, the data stream is withheld from disclosure to all entities within the virtual world outside of authorized participants and displays of the authorized participants.

Aspects of the invention are, for example, the presenter can remain in the immersive experience of the virtual world, and the presenter can use tools similar to tools used in real world presentations, for example pointers, and laser pointers. An environment is created in which virtual world conferences can be hosted, wherein the virtual world conference is similar to a real world conference.

An embodiment of the invention requires only standard infrastructure. Another embodiment requires only simple objects in the virtual world and thus does not need a proxy or to change a client of the virtual world system.

In a typical confidential meeting, there are, for example, three data channels which are to be protected, that is, to remain confidential. The three data channels are audio, video and text data channels. Embodiments of the invention are described herein which protect, for example, the video data channel. The video data channel, for example, provides a slide presentation. Features of the invention relate to how a presentation can be streamed as an interactive video or media, and how access to the streaming media can be controlled.

Another embodiment of the invention requires only standard functionality of the virtual world and has the advantage that media contents and animations in presentations can be played, i.e., the embodiment can support many presentation formats.

Embodiments of the invention employ a stream server that provides a video streaming media to the virtual world wherein the streaming media is referenced by a uniform resource locator (URL). Secure and confidential access control to the stream server is provided using a network, for example, an access controlled network, or a virtual private network (VPN). An access controlled network may be, for example, a secure network, a secure VPN or an access controlled VPN.

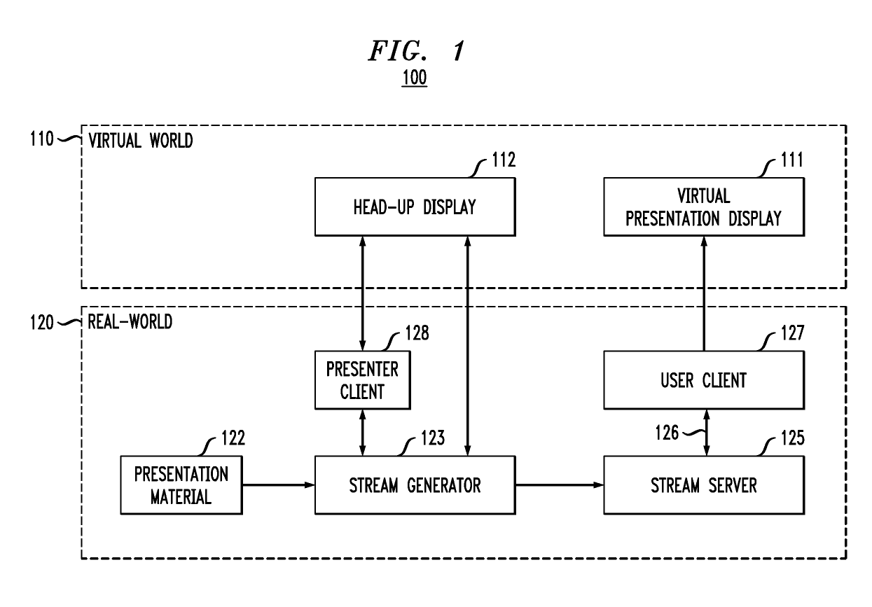

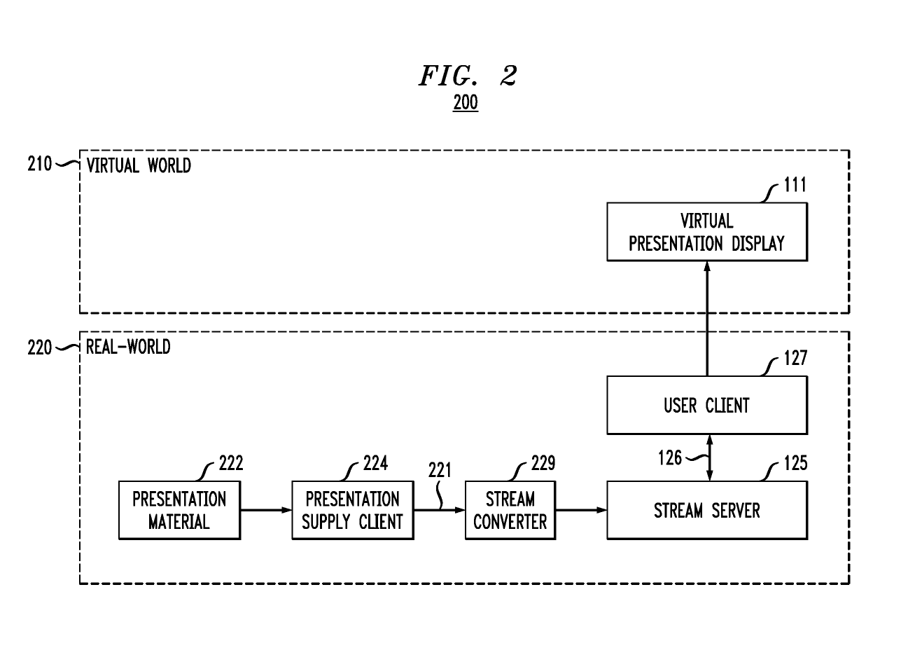

FIG. 1 illustrates a first system for providing a confidential presentation according to a first embodiment. In the first embodiment, a first streaming media is generated from first slides or other first presentation material and is controlled by the presenter using a head-up display displaying the presentation in the virtual world (e.g., displaying a virtual application). FIG. 2 illustrates a second system for providing a confidential presentation according to a second embodiment. In the second embodiment, a second streaming media is generated from second slides or other second presentation material; is controlled by the presenter using, for example, a conventional display; and uses screen capture via virtual network computing.

The first embodiment, shown in FIG. 1, comprises within a virtual world 110 a virtual presentation display 111 and a head-up display 112. The first embodiment further comprises within a real world 120 a user client 127, presentation material 122, a stream generator 123, a stream server 125, and a network 126. The first embodiment may optionally comprise a presenter client 128, that is, a client of the presenter. The network 126 comprises, for example, a secure network or an access controlled network such as a secure or access controlled VPN. The user client 127 and/or the presenter client 128 may, for example, comprise hardware (e.g., a processor and/or memory) and/or software. For example, the user client 127 may comprise software, hardware or both software and hardware that receives virtual world elements form a virtual world provider, receives a data stream from the stream server 125, merges the virtual world elements and the data stream to form virtual world display data, and provides for presentation to the user on, for example, the virtual presentation display 111. Note that although a singular user client 127 and virtual presentation display 111 is presented in some embodiments, there may be a plurality of user clients 127 and virtual presentation displays 111 in other embodiments, one for each user of a plurality of users, and all user clients 127 coupled to the stream server 125 via network 126.

Presentation material 122 comprises, for example slides, video, audio and/or animation. Presentation material 122 is provided to the stream generator 123. The stream generator 123 is coupled to the head-up display 112. The stream generator comprises, for example, a first computing resource or server, adapted to generation of streaming media. The stream generator 123 generates a media or data stream, herein referred to as a stream, from the presentation material and optionally from executed display commands. The stream comprises streaming media or streaming data. The stream further comprises media content, information and/or data within the presentation and optionally comprises information or data from executed display commands, for example, the position of a pointer. The stream comprises, for example, a multi-media stream, a video stream, a text stream or an audio/video stream. The stream may further comprise animations.

The head-up display 112 is provided, within the virtual world 110, to the presenter, for example, provided to an avatar of the presenter. The head-up display comprises, for example, a screen, or screens, presented on a client of the presenter client 128. The head-up display 112 displays to the presenter, and/or to the avatar of the presenter, the presentation material 122 and optionally provides, to the presenter, control commands for the presentation. Control commands are, for example, next slide, previous slide and pointer position. The control commands, executed by the presenter, are provided to the stream generation 123. In an alternate embodiment, the head-up display 112 is in the real world.

The stream generator 123 is coupled to the stream server 125. The stream server 125 comprises, for example, a second computing resource adapted to providing streaming media or streams to user clients 127. The stream server 125 receives the stream from the stream generator 123 and provides the stream to user clients 127. The stream is provided to the user clients 127 over the network 126. The network 126 is coupled to the stream server and to the user clients 127. The network 126 is, for example, a VPN. Each user client 127 is further coupled to the virtual presentation display 111. The virtual presentation display 111 displays, within the virtual world 110, the presentation to the user. The virtual presentation display 111 comprises, for example, a screen or display, coupled to, accessed by, or associated with the user client 127. For example, the virtual presentation display 111 is coupled to user client 127 over a secure or access controlled connection preventing the user client 127 from providing the stream to the virtual world 110 outside of the virtual presentation display 111. The user client 127 is coupled to the stream server 125 over the network 126, which may be a secure or access controlled.

The optional presenter client 128 is optionally coupled to the head-up display 112 and to the stream generator 123.

The second embodiment, shown in FIG. 2, comprises, within a virtual world 210, a virtual presentation display 111. The second embodiment further comprises, within a real world 220, a user client 127, presentation material 222, a presentation supply client 224, a stream converter 229, a stream server 125, and a network 126. The network 126 comprises, for example, a secure network or access controlled network, such as a secure or access controlled VPN.

Presentation material 222 comprises, for example slides, video, audio and/or animation. Presentation material 222 is provided to the presentation supply client 224. The presentation supply client 224 comprises a client under the control of the presenter and may comprise a display device or screen.

The presentation supply client 224 is coupled to the stream converter 229 by link 221. The stream converter 229 comprises, for example, a third computing resource or server. The stream converter 229 is adapted to capture the presentation from the presentation supply client and convert the presentation into streaming media, that is, into a media stream, herein referred to as a stream. The stream comprises streaming media or streaming data.

The presentation is captured from a screen, or screens, of the presentation supply client 224 by the stream converter 229 using, for example, screen capture technology. Screen capture technology comprises, for example, virtual network computing technology. Link 221 comprises, for example a virtual network computing connection between the presentation supply client 224 and the stream converter 229.

The stream comprises media content, information and/or data within the presentation and optionally comprises other object, information or data, for example, a pointer. The stream comprises, for example a multi-media stream, a video stream, a data stream or an audio/video stream. The stream may further comprise animations.

The stream converter is further coupled to the stream server 125. The stream server 125 comprises, for example, a fourth computing resource adapted to providing streaming media or data, that is, streams, to user clients 127. The stream server 125 receives the stream from the stream converter 229 and provides the stream to user clients 127. The stream is provided to the user clients 127 over the network 126. The network 126 is coupled to the stream server 125 and to the user clients 127. Each of the user clients 127 is further coupled to a virtual presentation display 111. The virtual presentation display 111 displays within the virtual world 210 the presentation to the user. The virtual presentation display 111 comprises, for example, a screen or display coupled to, accessed by, or associated with the user client 127. For example, the virtual presentation display 111 is coupled to user client 127 over a secure or access controlled connection preventing the user client 127 from providing the stream to the virtual world 210 outside of the virtual presentation display 111. The user client 127 is coupled to the stream server 125 over the network 126, which is a secure or access controlled network.

In a particular second embodiment, the presenter has two screens available, one that presents the virtual world and the presentation, the other is the screen of the presentation client. The particular second embodiment can be realized with standard technologies and without changes to the virtual world (e.g., a client of the virtual world).

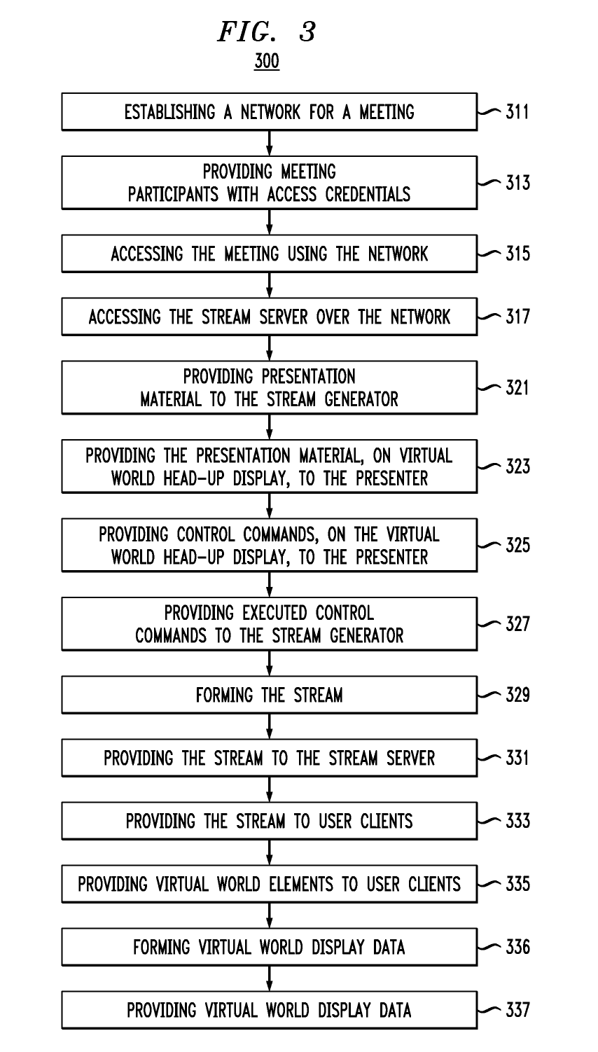

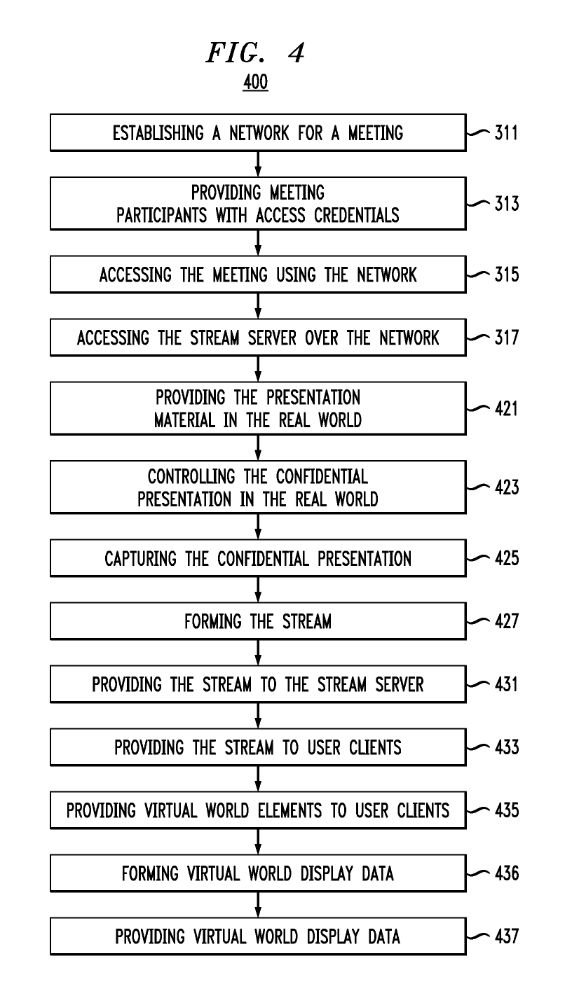

FIG. 3 illustrates a first method 300 of providing a confidential presentation according to the first embodiment of the invention. FIG. 4 illustrates a second method 400 of providing a confidential presentation according to the second embodiment of the invention. Both the first method 300 and the second method 400 have a first step 311, a second step, 313, a third step 315 and a fourth step 317 in common.

The first step 311 of methods 300 and 400 comprises establishing a network 126 for a meeting. For example, the network is a secure or access controlled network or a secure or access controlled VPN. The meeting host sets up the network 126 in a customary way known in the art. The second step 313 comprises providing meeting authorized participants with access credentials, for example, as part of the meeting invitation. Access credentials comprise, for example, meeting identifier and password. The host can provide the access by, for example, an email, an instant message, a text message or a phone call.

The third step 315 comprises accessing the meeting using the network 126. For the meeting, the host and the authorized participants join or access the meeting using the network 126 and displaying the access credentials. For example, obtaining access to the network 126 requires presentation of the access credentials. The fourth step comprises accessing the stream server 125 over the network 126. The user clients 127 access the stream server 125 over the network 126. Only hosts and participates, having the access credentials and using the network 126 have access to the stream server 125.

The following steps differ between the first method 300 and the second method 400.

The fifth step 321 of the first method 300 comprises providing presentation material 122 to the stream generator 123. The presentation material 122 is typically provided by the presenter; however, authorized participants may alternately or additionally provide presentation material 122.

The sixth step 323 of the first method 300 comprises providing the presentation material 122, on the virtual world head-up display 112, to the presenter. The stream generator 123 provides the presentation material 122 to the head-up display 112. The format for transfer of the presentation material 122 from the stream generator 123 to the head-up display 112 is not necessarily a streaming format, but may be other formats known in the art.

The seventh step 325 of the first method 300 comprises providing the control commands, on the virtual world head-up display 112, to the presenter. For one example, the stream generator 123 provides the control commands to the head-up display 112. For another example, the presenter client 128 may provide the control commands to the head-up display 112. The format for transfer of the control commands from the stream generator 123, or from the presenter client 128, to the head-up display 112 is not necessarily a streaming format, but may be other formats known in the art.

The eighth step 327 of the first method 300 comprises providing executed control commands to the stream generator 123. The control commands are executed by the presenter to control the presentation. The executed control commands are provided by the head-up display 112 and/or the presenter client 128 to the stream generator 123.

The ninth step 329 of the first method 300 comprises forming the stream. The presentation material 122, along with the executed control commands, is formed, by the stream generator 123, into the stream formed via streaming media or data. The stream generator 123 provides the presentation, along with the executed control commands, in a streaming format.

The tenth step 331 of the first method 300 comprises providing the stream to the stream server. The stream is provided by the stream generator 123.

The eleventh step 333 of the first method 300 comprises providing the stream to user clients 127 of authorized users. The stream is provided from the stream server 125 and over the network 126. The user clients 127 access the stream server 125 by, for example, addressing stream server 125 using a URL. Only authorized users and user clients 127 of authorized users, accessing the network 126, will be able to receive the presentation.

The twelfth step 335 of the first method 300 comprises providing virtual world elements to the user client 127. The virtual world elements may be, for example, avatars, objects, data or perceptual stimuli of the virtual world (e.g. of a modeled world or a modeled environment). The virtual world elements may be provided by, for example, the provider or service provider of the virtual world. In one embodiment, the provider of the virtual world is distinct or separate from the provider of the presentation.

The thirteenth step 336 of the first method 300 comprises forming virtual world display data comprising the data stream provided by the stream server 125 and the virtual world elements, for example, by merging the data stream with the virtual world elements. The formation of the virtual world display data may be done by the user client(s) 127.

The fourteenth and last step 337 of the first method 300 comprises providing, by the user client(s) 127, the virtual world display data for displaying the presentation (e.g., for displaying the presentation in the virtual world). The presentation may be displayed to the user on the virtual presentation display 111.

The fifth step 421 of the second method 400 comprises providing the presentation material in the real world 220. The presentation material 122 is provided to the presentation supply client 224. The presentation material 122 is typically provided by the presenter; however, authorized participants may alternately or additionally provide presentation material 122.

The sixth step 423 of the second method 400 comprises controlling the confidential presentation in the real world. The presenter controls the confidential presentation. Using the presentation supply client 224, the presenter controls the presentation in a traditional or real world manor. For example, the presenter advances through presentation material slides, on the presentation supply client, in the traditional or real world manor. Control of the presentation is also by a traditional or real world manor. For example, control is by indicating items on a slide with a mouse pointer.

The seventh step 425 of the second method 400 comprises capturing the confidential presentation. The presentation is captured from the presentation supply client 224 by the stream converter 229. The presentation is captured from a screen, or screens, of the presentation supply client 224 by the stream converter 229 using, for example, screen capture technology. Screen capture technology comprises, for example, virtual network computing technology. Captured screens may optionally comprise a pointer for indicating objects or areas on the screen.

The eighth step 427 of the second method 400 comprises forming the stream. The presentation material 122, as captured by the stream converter 229, is formed, by the stream converter 229, into streaming media or data, that is, into the stream. The stream converter 229 provides the presentation in a streaming format.

The ninth step 431 of the second method 400 comprises providing the stream to the stream server. The stream is provided by the stream converter 229.

The tenth step 433 of the second method 400 comprises providing the stream to user clients 127 of authorized users. The stream is provided from the stream server 125 and over the network 126. The user clients 127 access the stream server 125 by, for example, addressing stream server 125 using a URL. Only authorized users and user clients 127 of authorized users, accessing the network 126, will be able to receive the presentation.

The eleventh step 435 of method 400 is the same as the twelfth 335 step of method 300, the twelfth step 436 of method 400 is the same as the thirteenth step 336 of method 300, and the thirteenth step 437 of method 400 is the same as the fourteenth step 337 of method 300.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 3 and 4, which are flow diagrams or flowcharts of the method 300 and 400, respectively, the flowcharts and block diagrams in the Figure illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustrations, and combinations of blocks in the block diagrams and/or flowchart illustrations, can be implemented by special purpose hardware-based systems that perform the specified functions or acts, or combinations of special purpose hardware and computer instructions.

Accordingly, techniques of the invention, for example as depicted in FIGS. 1-4, can also include, as described herein, providing a system, wherein the system includes distinct modules (e.g., software modules). By way of example only, the modules may include: a data stream provision module adapted to provide a data stream by a stream server (e.g., a stream server of a provider of a presentation) to a participant client, a virtual world elements provision module adapted to provide virtual world elements from a virtual world provider (e.g., a provider or service provider of a virtual world) to the participant client, a formation module adapted to form virtual world display data comprising the data stream and the virtual world elements, and a presentation module adapted to present the virtual world display data to the user. These and other modules may be adapted, for example, to perform the steps of methods 300 and 400 illustrated in FIGS. 3 and 4, respectively.

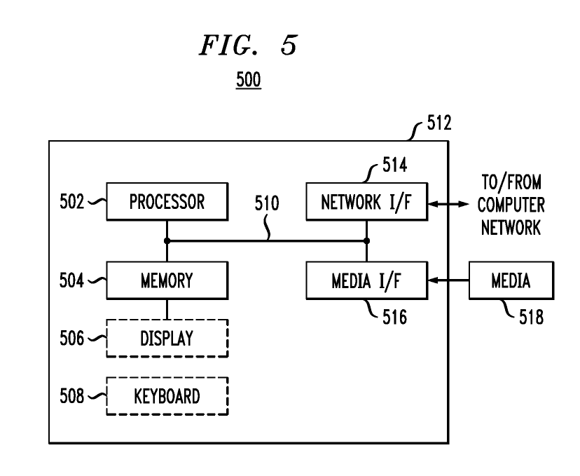

One or more embodiments can make use of software running on a general purpose computer or workstation. With reference to FIG. 5, such an implementation employs, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

A data processing system suitable for storing and/or executing program code can include at least one processor 502 coupled directly or indirectly to memory elements 504 through a system bus 510. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 508, display 506, pointing device, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for providing a confidential presentation, the method comprising the step of:
providing a data stream by a stream server of a provider of the confidential presentation to a participant client;
providing virtual world elements from a virtual world provider to the participant client, wherein the virtual world provider is distinct from the provider of the confidential presentation; and
forming, by the participant client, virtual world display data comprising the data stream and the virtual world elements.

2. The method of claim 1, wherein the data stream is adapted for accessing over an access controlled network by requiring a showing of access credentials to access the data stream.

3. The method of claim 1, wherein the data stream comprises streaming media comprising presentation material of the confidential presentation.

4. The method of claim 1 further comprising the steps of:
forming the data stream by a device; and
providing the data stream from the device to the stream server.

5. The method of claim 3 further comprising the steps of:
providing the presentation material to a stream generator;
providing the presentation material on a presenter display of a presenter; and
providing control commands on the presenter display, wherein the control commands are adapted to be executed by the presenter and, after execution, provided to the stream generator, and wherein the stream generator forms the data stream and provides the data stream to the stream server.

6. The method of claim 3 further comprising the steps of:
providing the presentation material to a presenter client of a presenter; wherein the presenter client is adapted for controlling the confidential presentation; and
capturing at least a portion of the confidential presentation from the presenter client onto a stream converter, wherein the stream converter forms the data stream and provides the data stream to the stream server.

7. The method of claim 1, wherein the data stream is provided to at least one authorized participant and withheld from nonparticipants.

8. The method of claim 2, wherein the data stream is provided to at least one authorized participant by providing the at least one authorized participant with access credentials, and by accessing the confidential presentation by the at least one authorized participant, using the access controlled network and the access credentials, and wherein the data stream is provided, over the access controlled network, by the stream server to at least one authorized participant client of the at least one authorized participant.

9. The method of claim 2, wherein the access controlled network is at least one of a virtual private network and a secure network.

10. The method of claim 1, wherein the step of providing the data stream comprises accessing the stream server by the participant client by addressing with a uniform resource locator.

11. The method of claim 1, wherein the data stream comprises video data.

12. The method of claim 5, wherein the presenter display comprises a head-up display adapted to display a virtual application.

13. The method of claim 6, wherein the at least a portion of the confidential presentation is captured using screen capture technology.

14. The method of claim 13, wherein the screen capture technology comprises virtual network computing technology.

15. The method of claim 1, wherein the virtual world display data is adapted for presentation on a display coupled to the participant client.

16. The method of claim 1, wherein the confidential presentation is adapted to be provided within at least one of a virtual world, a computing environment associated with a virtual application, and a virtual application, and wherein said providing is to a participant of the confidential presentation.

17. Apparatus for providing a confidential presentation, the apparatus comprising:
a stream server of a provider of the confidential presentation; and
a device for forming a data stream, the apparatus configured to:
provide the data stream by the stream server to a participant client;
provide virtual world elements from a virtual world provider to the participant client, wherein the virtual world provider is distinct from the provider of the confidential presentation; and
form, by the participant client, virtual world display data comprising the data stream and the virtual world elements.

18. The apparatus of claim 17, wherein the data stream comprises streaming media comprising presentation material of the confidential presentation, the apparatus further configured to:
provide the presentation material to a stream generator, wherein the device for forming the data stream comprises the stream generator;
provide the data stream from the device to the stream server;
provide the presentation material on a presenter display of a presenter, wherein the presenter display comprises a head-up display adapted to display a virtual application; and
provide control commands on the presenter display, wherein the control commands are adapted to be executed by the presenter and, after execution, provided to the stream generator, and wherein the stream generator forms the data stream and provides the data stream to the stream server.

19. The apparatus of claim 17 wherein the data stream comprises streaming media comprising presentation material of the confidential presentation, the apparatus further configured to:
provide the presentation material to a presenter client of a presenter, wherein the presenter client is adapted for controlling the confidential presentation; and
capture at least a portion of the confidential presentation from the presenter client onto a stream converter, wherein the device for forming the data stream comprises the stream converter, and wherein the stream converter provides the data stream to the stream server.

20. The apparatus of claim 17, wherein the data stream comprises video data.

21. The apparatus of claim 19, wherein the at least a portion of the confidential presentation is captured using screen capture technology.

22. The apparatus of claim 21, wherein the screen capture technology comprises virtual network computing technology.

23. The apparatus of claim 17, wherein the confidential presentation is adapted to be provided within at least one of a virtual world, a computing environment associated with a virtual application, and a virtual application, and wherein said providing is to a participant of the confidential presentation.

24. Apparatus for providing a confidential presentation, the apparatus comprising:
a memory; and
a processor coupled to the memory and configured to:
provide a data stream by a stream server of a provider of the confidential presentation to a participant client;
provide virtual world elements from a virtual world provider to the participant client, wherein the virtual world provider is distinct from the provider of the confidential presentation; and
form, by the participant client, virtual world display data comprising the data stream and the virtual world elements.

25. A system for providing a confidential presentation, the system comprising:
a data stream provision module adapted to provide a data stream by a stream server of a provider of the confidential presentation to a participant client;
a virtual world elements provision module adapted to provide virtual world elements from a virtual world provider to the participant client, wherein the virtual world provider is distinct from the provider of the confidential presentation; and
a formation module adapted to form, by the participant client, virtual world display data comprising the data stream and the virtual world elements.

26. A computer program product for providing a confidential presentation, the computer program product comprising a computer readable storage medium having computer readable program code embodied therewith, the computer readable program code comprising computer readable program code configured to perform the step of:
providing a data stream by a stream server of a provider of the confidential presentation to a participant client;
providing virtual world elements from a virtual world provider to the participant client, wherein the virtual world provider is distinct from the provider of the confidential presentation; and
forming, by the participant client, virtual world display data comprising the data stream and the virtual world elements.
